(19) United States
(12) Patent Application Publication
(10) Pub. No.: US 2014/0039713 A1
(43) Pub. Date: Feb. 6, 2014

(54) SYSTEM AND METHOD FOR FAIL SAFE OPERATION OF LOW VOLTAGE OCCUPANCY SENSORS

(71) Applicants: Robert L. Hick, Newberg, OR (US); Richard A. Leinen, Wilsonville, OR (US)

(72) Inventors: Robert L. Hick, Newberg, OR (US); Richard A. Leinen, Wilsonville, OR (US)

(73) Assignee: LEVITON MANUFACTURING COMPANY, INC., Melville, NY (US)

(21) Appl. No.: 13/564,190

(22) Filed: Aug. 1, 2012

(51) Int. Cl. G06F 1/26

(52) U.S. Cl. 700/295

(57) ABSTRACT

A system and method are disclosed for providing fail-safe operation of an occupancy sensor so that a load associated with the sensor will be energized in the event that the sensor malfunctions. Short voltage pulses are applied to a signal line by an occupancy sensor. A load control device recognizes the pulses as an indication that the sensor is in a healthy condition. If the load control device does not recognize the voltage pulses, it assumes the sensor is faulty and energizes the load (light) associated with the monitored space. The voltage pulses are different from the normal signals sent by the sensor to the load control device that indicate an “occupied” condition of the space. Other embodiments are described and claimed.

### FIELD OF THE DISCLOSURE

The present disclosure relates generally to occupancy sensing systems, and more particularly to an improved system and method for providing fail-safe operation of occupancy sensing systems.

### BACKGROUND OF THE DISCLOSURE

Occupancy sensors are designed to save energy by detecting the presence of a moving object in an area of coverage and switching a light source on and off depending upon the presence of the moving object. For example, when a moving object is detected within the area of coverage, the light source is turned on. Alternatively, when motion is not detected indicating that the area of coverage is not occupied, the light source is turned off after a predetermined period of time. Occupancy sensors thus facilitate electrical energy savings by automating the functions of a light switch or an electrical outlet.

Occupancy sensors can be used to monitor any of a variety of locations, including office spaces, hotel rooms, stairwells, and the like. Where occupancy sensors are used to control lighting in spaces such as stairwells or other areas where visibility is important, sensor failure can present a safety hazard because lighting may remain off even when a person has entered the area. To address such potential safety hazards, the National Fire Protection Association (NFPA) 101 Life Safety Code requires that motion sensor-type lighting switches associated with building egresses be equipped for fail-safe operation.

Standard occupancy sensor control wire functionality provides a forced high voltage level (approximately +24 Vdc) when the sensor detects occupancy, and leaves the line in a high impedance state when the occupancy is not detected (i.e., indicating a vacant condition). This feature allows multiple occupancy sensors to be connected to the same input without causing bus contention between sensors. Such multiple sensor arrangements are often used when covering large areas. When the line is in the high voltage state, a load switching device typically turns on the lights. This represents a “safe” condition. When occupancy is not detected (a vacant condition) the load switching device turns off the lights. As will be appreciated, this arrangement provides a “safe” configuration only if it can be assured that the occupancy sensor is functioning properly. The problem with such arrangements is that they provide no way to automatically determine if an occupancy sensor has failed, and thus the lights may not turn on even if a person has entered the space. This is because with current systems there is functionally no difference between an intentionally signaled “vacant” condition (i.e., the line is left in a high impedance state), and an unconnected input that could be due to a failure of the sensor. Thus, sensor failure can only be diagnosed when a person enters the space and visually determines that the lights have not come on. As previously noted, this can present a safety hazard if the lights are intended to illuminate a stairwell or the like.

It would, therefore, be desirable to provide a fail-safe arrangement for an occupancy sensor that ensures that space lighting is illuminated when the sensor is determined to be in a “failed” state. It would also be desirable to provide an arrangement in which a failed occupancy sensor can be automatically identified so that repair can be scheduled in an efficient manner.

### SUMMARY OF THE DISCLOSURE

A load control system is disclosed. The load control system may comprise an occupancy sensor for providing an occupancy signal representative of occupancy of a monitored area, and for providing a health signal representative of a health of the occupancy sensor. The system may include a load control device coupled to the occupancy sensor, the load control device configured to receive the occupancy signal and the health signal from the occupancy sensor, and to control an electrical load based on at least one of the received occupancy signal and the health signal.

A method is disclosed for controlling an electrical load using an occupancy sensor. The method may comprise: receiving, at the load control device, a health signal representative of a health status of the occupancy sensor; receiving, at a load control device, an occupancy signal representative of an occupancy status of a monitored space; and controlling an electrical load based on at least one of the occupancy signal and the health signal.

### BRIEF DESCRIPTION OF THE DRAWINGS

By way of example, a specific embodiment of the disclosed device will now be described, with reference to the accompanying drawings, in which:

FIG. 1 is a schematic diagram of an embodiment of the disclosed system;

FIG. 2 illustrates an exemplary signaling scheme for use with the system of FIG. 1;

FIG. 3 is a schematic diagram of an alternative embodiment of the disclosed system;

FIGS. 4A-4D illustrate exemplary signaling schemes for use with the system of FIG. 3;

FIG. 5 is a flow chart illustrating an exemplary method of operating the system of FIG. 1; and

FIG. 6 is a flow chart illustrating an exemplary method of operating the system of FIG. 3.

### DETAILED DESCRIPTION

A system and method are disclosed for providing fail-safe operation of an occupancy sensor so that a load associated with the sensor will be energized in the event that the sensor malfunctions. As will be appreciated, this functionality is desirable for applications in which lighting systems can have an impact on public safety. Examples of such applications include, but are not limited to, lighting that serves public staircases in parking lots or parking ramps, where the public safety could be compromised if the lighting fails to energize due to some fault in the associated occupancy sensor. The disclosed system and method may find application using a variety of different types of occupancy sensing technologies, load control devices, and loads.

The disclosed system and method may be used with arrangements in which a single occupancy sensor is used to monitor a targeted area. In some embodiments, the disclosed system and method may apply to arrangements in which multiple occupancy sensors are tied together to cover an area larger than that which an individual sensor can cover. The disclosure provides a system and method for applying a short voltage pulse that pulls the occupancy sensor out of a high impedance state, and applies up to about +24 Vdc during periods in which the occupancy sensor does not detect occupancy. These short voltage pulses may be applied on a periodic basis to make the load control device aware that the occupancy sensor is alive and working

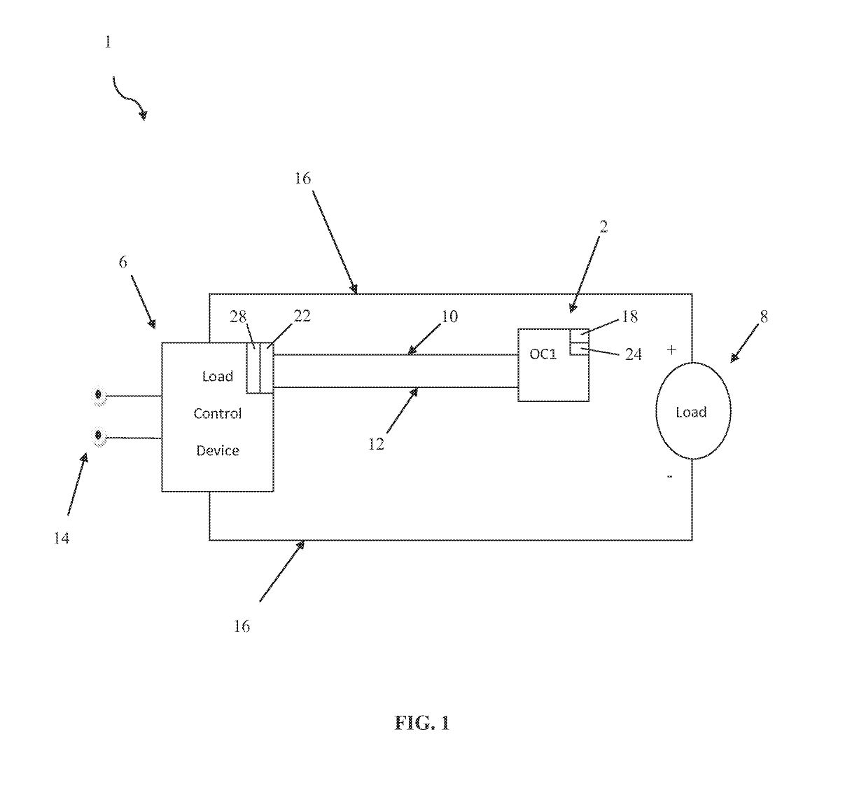

Referring to FIG. 1, an exemplary occupancy sensing system 1 is illustrated. The system may include an occupancy sensor 2 associated with a load control device 6 and a load 8. The load control device 6 may receive signals from the occupancy sensor 2 via signal line connection 10. The load control device 6 may provide power to the occupancy sensor 2 via power line 12. The power provided by the load control device 6 may be direct current (DC) power, which may be provided via any suitable wiring connection. The load control device 6 may be powered via line power from external line connection 14. Alternatively, the load control device 6 may be powered by an internal battery (not shown). As will be described, the load control device 6 may selectively energize the load 8 via power lines 16.

Although lines 10, 12, 16 are illustrated as single lines, it will be appreciated that these lines may be multiple physical wiring lines depending on the type of wiring used. In addition, the occupancy sensor 2 may comprise any of a variety of sensor technologies, such as passive infrared sensors, ultrasonic sensors, dual infrared-ultrasonic sensors, and the like. Further, the load 8 can be any of a variety of electrical loads, such as lighting, heating, ventilation and the like.

The occupancy sensor 2 and the load control device 6 may each include a processor 18, 22 for controlling one or more operational aspects of the associated device and for commanding and decoding communication signals sent between the sensors and the load control device. In addition, each processor 18, 22 may have local memory 24, 28 associated therewith for storing information generated by, and transferred between, the sensors and the load control device. The memory 24, 28 may be any of a variety of volatile or non-volatile memory devices.

In some embodiments, occupancy of a monitored space may be indicated when the occupancy sensor 2 applies a voltage level on the signal line 10. For example, the voltage level to indicate occupancy may be +24 Vdc. It will be appreciated that this level is not critical, and that other suitable voltage levels may be used to identify occupancy in a monitored space. In one exemplary embodiment, movement in a monitored space is indicated when the signal line voltage rises from 0V to +24 Vdc.

When the load control device 6 receives an occupancy signal from the occupancy sensor 2 it may control operation of the associated load 8 accordingly. For example, in response to an “occupied” signal from the occupancy sensor 2, the load control device 6 may function to energize the load 8 by providing power via power line 16. Although the illustrated embodiment includes a single occupancy sensor 2, a single load control device 6, and a single load 8, it will be appreciated that greater numbers of sensors, loads and load control devices could be used in combination to provide an occupancy sensing system 1 having a desired functionality and coverage. For example, it is expected that an area such as a public parking garage can have multiple different stairwells that would be monitored by multiple occupancy sensors. Multiple loads could be associated with each occupancy sensor. Alternatively, multiple occupancy sensors could be associated with each load. Further combinations of components are contemplated, as will be appreciated by one of ordinary skill in the art.

As previously noted, it may be desirable to provide an automatic indication of the “health” of the occupancy sensors employed in the sensing system 1. In some embodiments, in addition to signaling occupancy of a monitored space, the occupancy sensor 2 may be configured to provide information regarding the health of the sensor 2 to the load control device 6. The load control device 6 may be configured to receive this information via signal line 10, and may recognize this information and take one or more actions based on the received health information.

In some embodiments, health information may be conveyed as a series of voltage pulses impressed on the signal line 10 (i.e., the line used to indicate occupancy). These voltage pulses may be commanded by the processor 18 associated with the occupancy sensor 2. The load control device processor 22 may take any of a variety of actions in response to detection of occupancy signal and/or the health signal. For example, upon receiving the occupancy signal from the occupancy sensor 2, the load control device 6 may energize the load 8 associated with the space being monitored by the signaling detector. In one embodiment, this may involve turning on the lights associated with the signaling sensor. Upon receiving the health information signal, the load control device 6 may maintain the load 8 in a current state (either energized or not energized). By contrast, if the load control device 6 does not receive the health information signal from the occupancy sensor 2, the load control device may energize the load 8 associated with that sensor, since lack of a signal would be indicative of a faulty sensor.

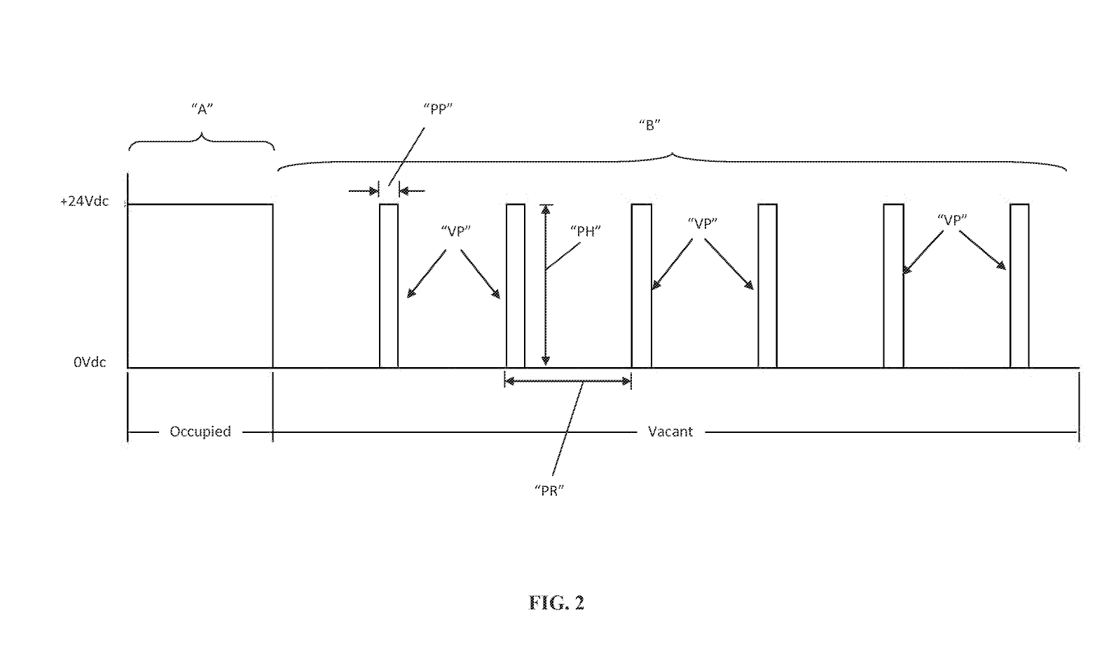

The health information signal may be transmitted using any of a variety of electrical signaling techniques. In one embodiment, the occupancy sensor processor 18 may apply a series of short voltage pulses on the control line 10. These short voltage pulses may be of a predetermined level, predetermined duration and predetermined periodicity. An exemplary pulse scheme is shown in FIG. 2. For example, during periods of occupancy (occupancy period “A”), the occupancy sensor 18, 20 may apply a voltage of +24 Vdc on the signal line 10. During this period, the load control device may energize the load 8. When the occupancy sensor 2 no longer indicates the space as occupied, the occupancy sensor 2 switches its output to high impedance. In one exemplary embodiment, a pull-down resistor on the input of the control device may cause the input to go to 0 Vdc.

During the vacancy period (period “B”), the occupancy sensor 2 may apply a voltage pulse “VP” on the signal line 10 at a pulse rate “PR”, which may be, in one non-limiting example, a pulse about once every 5 seconds. As noted, these voltage pulses may be timed and commanded by the processor 18 associated with the occupancy sensor 2. The voltage pulse “VP” may be held for a pulse period “PP,” which, in one non-limiting example, may be less than about one second. In an exemplary embodiment the pulse period “PP” may be about 0.25 seconds. The voltage pulse “VP” may be applied at any of a variety of magnitudes. In one embodiment the voltage pulse “VP” is a +24 Vdc pulse, though this is not critical and other voltage levels may be used. The voltage pulses “VP” will continue to be applied on the signal line 10 as long as the occupancy sensor 2 is in vacancy mode.

The load control device 6 may be configured such that when it recognizes a high voltage level (e.g., +24 Vdc) it starts a timer to ensure that the signal remained “high” for at least the amount of time of the pulse period “PP.” If the signal remains high only for pulse period “PP,” the load control device 6 recognizes the voltage pulse as an indication that the sensor is healthy, and it does not turn on the associated load 8. If, however, the signal remains high after the timer times out, then the load control device 6 recognizes the voltage as an indication that the space is “occupied,” and turns on the load 8. If the load control device 6 doesn't receive any voltage pulses for a predetermined period, it would assume that the associated occupancy sensor has failed, and it turns on the load 8, thus providing the desired fail-safe functionality.

When the load control device 6 identifies a failed occupancy sensor, visual indicator such as a light emitting diode (LED) may be provided on the load control device 6 to indicate failure of the connected occupancy sensor 2. In addition, the load control device 6 may be coupled to a private or public network to facilitate remote notification when a failure of the occupancy sensor 2 occurs. In some embodiments sensor failure information may be sent via the Internet to a web page to enable remote monitoring of occupancy sensors. A building manager or other authorized individual or agency may monitor this information to determine if sensor replacement is required. In some embodiments the remote notification may be sent in an e-mail or a text message to one or more mobile or desktop computers.

The load control device 6 may be configured to recognize the short periodic voltage pulses as indicators of the sensor's health, and not as an occupancy indication by the sensor. In one embodiment, the processor 22 associated with the load control device 6 may be programmed to distinguish the voltage pulses from normal occupancy signals. In other embodiments, this recognition functionality can be implemented in hardware. Regardless of the specific implementation, the load control device 6 may recognize the received periodic voltage pulses as an indication that the occupancy sensor is healthy, and may distinguish the pulses from a signal indicating that the load 8 should be switched on due to a sensed occupancy condition.

If the load control device 6 does not sense this periodic pulse it may recognize this as an indication that the associated occupancy sensor 2 has failed, and it may energize the load 8 to provide illumination of the space associated with the “failed” sensor. In one embodiment, the voltage pulses “VP” can be applied by the processor 18, 20 associated with the occupancy sensor 2. The voltage pulses “VP” may be recognized by the processor 22 associated with the load control device 6.

In the above described arrangement, the occupancy sensor 2 is configured to operate in combination with a load control device 6 that is capable of recognizing “health” signaling from the sensors. The disclosed sensor may, however, be used with conventional load control devices (i.e., devices that are not capable of recognizing these voltage pulses). Thus, the occupancy sensor 2 may be configurable to deactivate the health signaling feature. In one embodiment, the occupancy sensor 2 may have a dip-switch, button, toggle or other user input that would enable the heartbeat functionality to be turned on or off

As noted in relation to FIG. 2, the voltage pulses “VP” may be applied at about +24 Vdc. Thus, the voltage pulses of the FIG. 2 embodiment are the same magnitude as the voltage which is applied to signal an occupied condition of the monitored space. In an alternative embodiment, the voltage pulses “VP” may be driven at a predetermined voltage that is substantially lower than the voltage of a typical occupancy signal (i.e., lower than +24 Vdc). For example, the predetermined voltage may be lower than a a logic trip point of the load control device's input. Thus, the predetermined voltage may be less than about +12 Vdc. One advantage of using a reduced voltage pulse is that an occupancy sensor 2 configured as such could be used with standard load control devices (i.e., those that don't recognize the voltage pulsing feature) without having to provide a deactivation feature on the sensor. This is because an ordinary load control devices would normally not recognize such a low voltage pulse since the voltage would be below the device's logic trip point. Such an arrangement would not provide the previously described fail-safe functionality, but it would allow the sensor 2 to be used with all load control devices, and not just those configured to recognize the applied “health” pulses.

Any of the above described embodiments may be implemented using processors associated with the occupancy sensor 2 and a processor associated with the load control device 6. By implementing the arrangement in software associated with the processors, changes to device wiring may be avoided. The scheme may alternatively be implemented using processors associated with the occupancy sensor 2 and hardware in the receiver (e.g., RC constants could provide the timeout functionality described above).

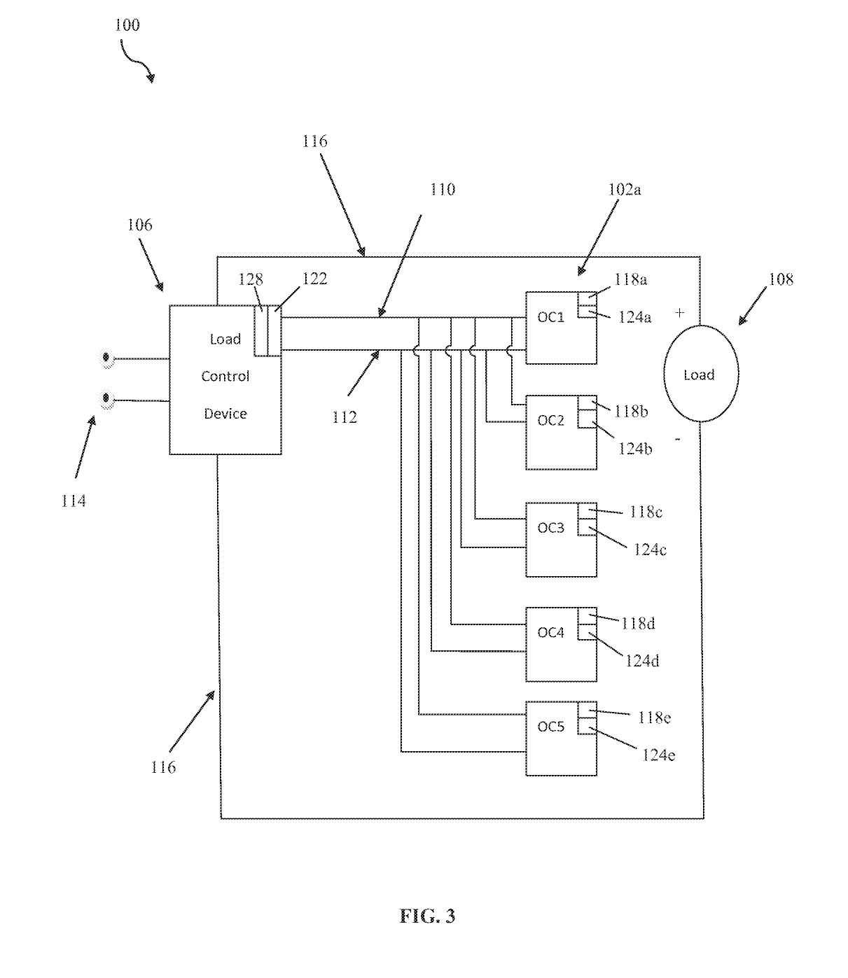

Referring to FIG. 3, an exemplary occupancy sensing system 100 is illustrated in which a plurality of occupancy sensors 102a-e can be monitored using a single load control device 106 and load 108. Such a system may be useful for applications in which a monitored area is too large to be serviced by a single occupancy sensor. In the illustrated embodiment, the system 100 includes first, second, third, fourth and fifth occupancy sensors 102a-e. It will be appreciated, however, that greater or fewer numbers of sensors can be monitored in this manner. As with the embodiment described in relation to FIGS. 1 and 2, the load control device 106 may receive signals from the occupancy sensors 102a-e via signal line connection 110. The load control device 6 may provide power to the occupancy sensor 102 via power line 112. The power provided by the load control device 106 may be direct current (DC) power, which may be provided via any suitable wiring connection. The load control device 106 may be powered via line power from external line connection 114. Alternatively, the load control device 106 may be powered by an internal battery (not shown). The load control device 106 may selectively energize the load 108 via power lines 116 in the manner previously described in relation to the embodiment of FIGS. 1 and 2.

Although lines 110, 112, 116 are illustrated as single lines, it will be appreciated that these lines may be multiple physical wiring lines depending on the type of wiring used. In addition, the occupancy sensors 102a-e may comprise any of a variety of sensor technologies, such as passive infrared sensors, ultrasonic sensors, dual infrared-ultrasonic sensors, and the like. Further, the load 108 can be any of a variety of electrical loads, such as lighting, heating, ventilation and the like.

The occupancy sensors 102a-e and the load control device 106 may each include a processor 118a-e, 122 for controlling one or more operational aspects of the associated device and for commanding and decoding communication signals sent between the sensors and the load control device. In addition, each processor 118a-e, 122 may have local memory 124a-e, 128 associated therewith for storing information generated by, and transferred between, the sensors and the load control device. The memory 124a-e, 128 may be any of a variety of volatile or non-volatile memory devices.

In some embodiments, occupancy of a monitored space may be indicated when one of the occupancy sensors 102a-e applies a voltage level on the signal line 110. For example, the voltage level to indicate occupancy may be +24 Vdc. It will be appreciated that this level is not critical, and that other suitable voltage levels may be used to identify occupancy in a monitored space. In one exemplary embodiment, movement in a monitored space is indicated when the signal line voltage rises from 0V to +24 Vdc.

When the load control device 106 receives an occupancy signal from one of the occupancy sensors 102a-e it may control operation of the associated load 108 accordingly. For example, in response to an “occupied” signal from the occupancy sensor 102a-e, the load control device 106 may function to energize the load 108 by providing power via power line 116.

As with the embodiment described in relation to FIGS. 1 and 2, the system 100 may facilitate automatic monitoring of the “health” of the occupancy sensors 102a-e employed in the sensing system 100. Thus, the occupancy sensors 102a-e may be configured to provide information regarding their health to the load control device 106. The load control device 106 may be configured to receive this information via signal line 110, and may recognize this information and take one or more actions based on the received health information.

In some embodiments, health information may be conveyed as a series of voltage pulses “VP” impressed on the signal line 110 (i.e., the line used to indicate occupancy). These voltage pulses “VP” may be commanded by the processor 118a-e associated with the occupancy sensor 102a-e. The load control device processor 122 may take any of a variety of actions in response to detection of occupancy signal and/or the health signal. For example, upon receiving the occupancy signal from one or more of the occupancy sensors 102a-e, the load control device 106 may energize the load 108 associated with the space being monitored by the signaling detector. In one embodiment, this may involve turning on the lights associated with the signaling sensor. Upon receiving the health information signal, the load control device 106 may maintain the load 108 in a current state (either energized or not energized). By contrast, if the load control device 106 does not receive the health information signal from one or more of the occupancy sensors 102a-e, the load control device may energize the load 108 associated with that sensor, since lack of a signal would be indicative of a faulty sensor.

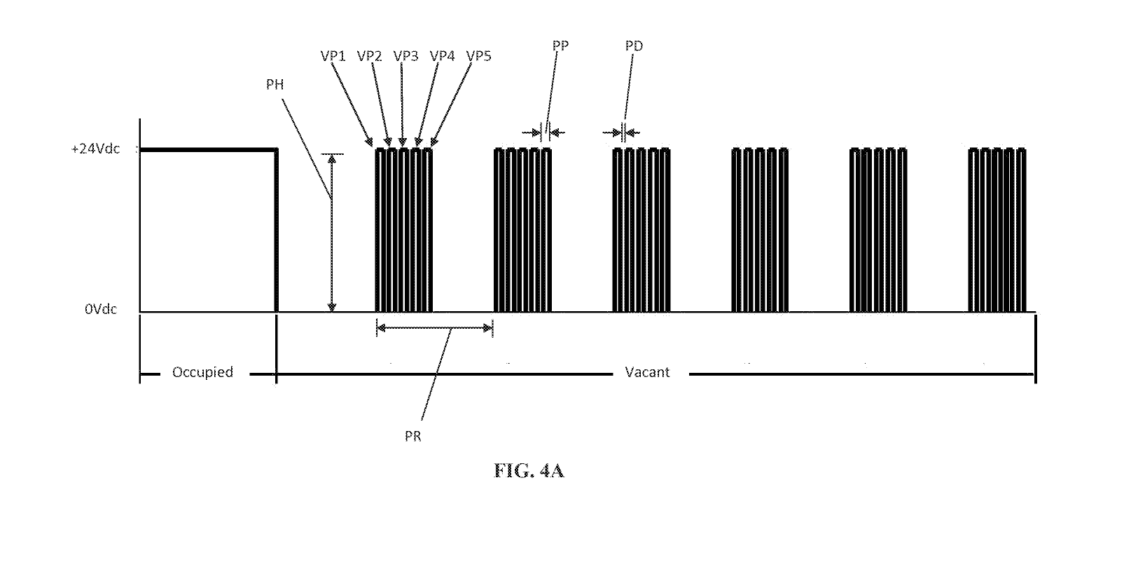

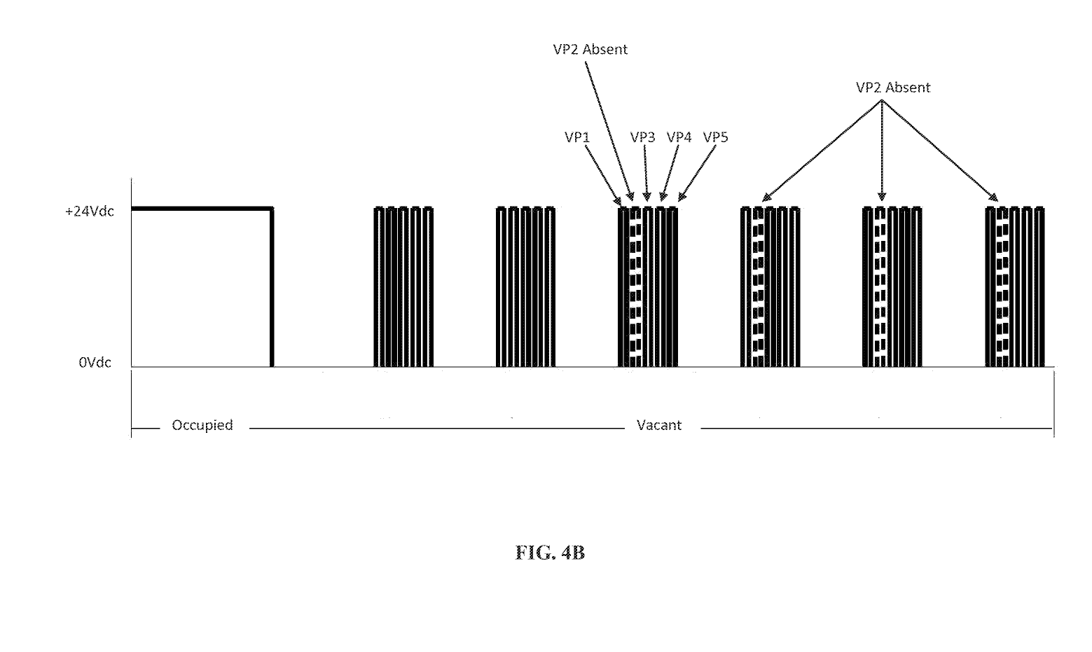

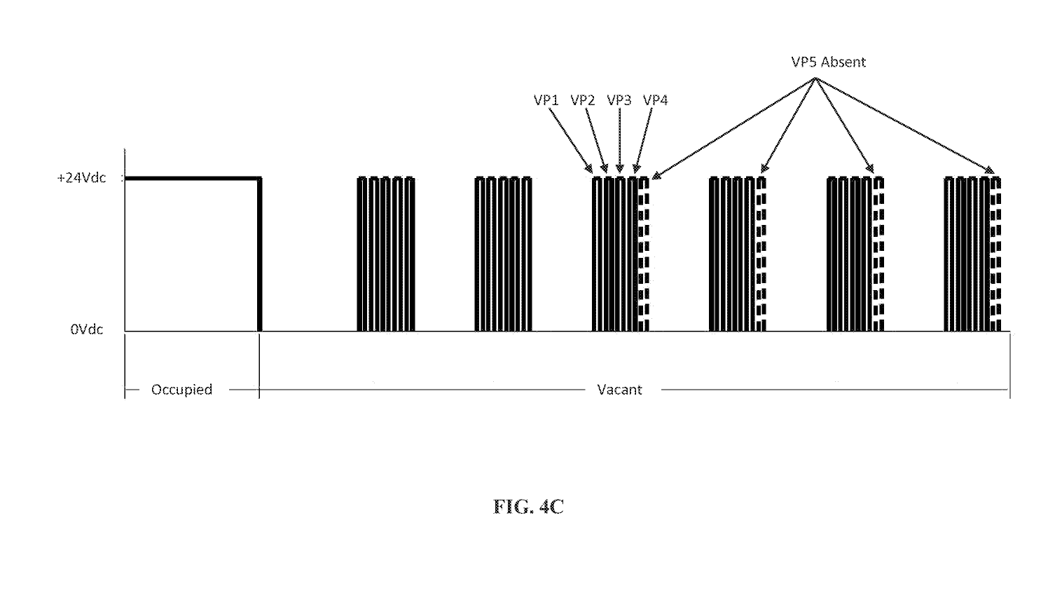

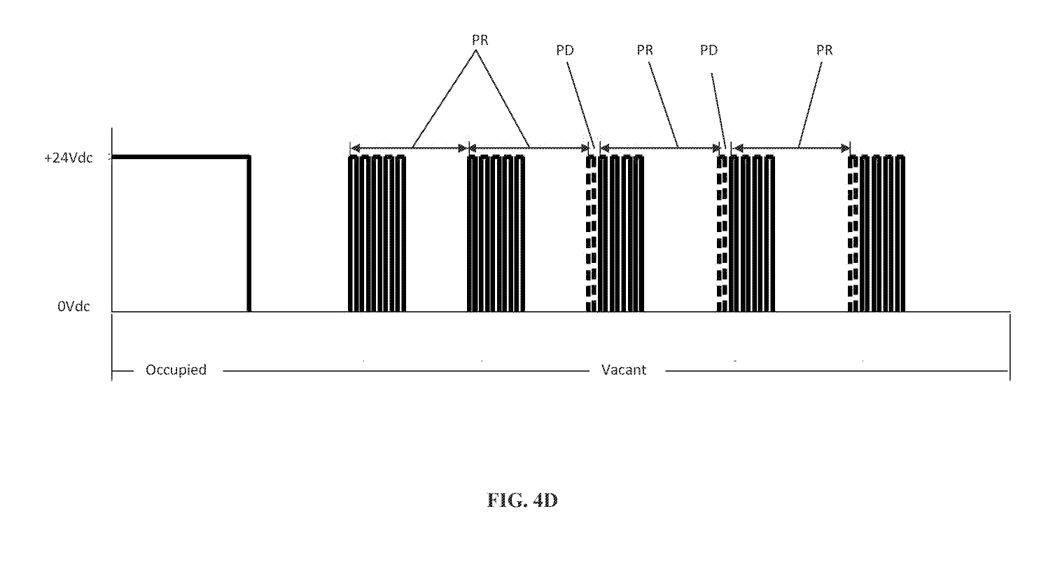

The health information signal may be transmitted using any of a variety of electrical signaling techniques. In one embodiment, the occupancy sensor processors 18a-e may apply a series of short voltage pulses “VP” on the control line 110. These short voltage pulses may be of a predetermined level (pulse height “PH”), predetermined duration (pulse period “PP”) and predetermined periodicity (pulse rate “PR”), as described previously in relation to the embodiment of FIGS. 1 and 2. Exemplary pulse schemes are shown in FIGS. 4A-4D. The heartbeat (i.e., voltage pulse) timeline shown in FIG. 4A is similar to the time line shown in FIG. 2, with the exception that instead of one periodic voltage pulse, there are as many pulses as there are sensors. Thus, in the illustrated embodiment there are five pulses VP1-VP5 associated with the five exemplary sensors 102a-e. The FIG. 4A timeline shows all five sensors 102a-e sending a heartbeat pulse indicative of the health of the sensor (i.e., all five sensors are functioning).

Each sensor 102a-e may have a configuration control (e.g., a DIP switch, rotary encoder, etc.) that would be used to control the heartbeat functionality. For example, a setting of zero may disable the vacancy heartbeat to enable the sensor to be used in systems that do not recognize the heartbeat signaling functionality. A value of one or higher may enable the vacancy heartbeat, and may also serve to order the pulses from each sensor.

Configuration rules may be applied to enable the system 100 to recognize that the presence or absence of a particular voltage pulse is associated with a particular sensor 102a-e. In one exemplary embodiment, each sensor 102a-e may be configured with a unique number (e.g., 1, 2, 3, 4, or 5). One of the sensors 102a-e may start with the configuration number “1.” The remaining sensors should have numbers that follow one another with no skipped numbers.

Each sensor 102a-e may monitor the state of its output line 110 whenever it is in the vacant, high impedance, state. The sensor configured as “1” would start the pulse train every “x” seconds (PR=5 seconds, for example) with a pulse held for 0.x seconds (PP=0.1 seconds, for example). The sensor configured as “2” may sense this pulse and output its own pulse 0.y seconds (pulse delay “PD”=0.2 seconds, for example) later. This would be followed by the sensor configured as “3,” and so on. After the last pulse it asserted (in the illustrated embodiment, this would be from sensor 102e (i.e., VP5), sensor “1” will start the pulse train again “z” seconds (5 seconds, for example) after its last assertion.

As noted, FIG. 4A shows a pulse scheme in which each of the sensors 102a-e sends a pulse in the configured manner so that a series of five pulse-groups are received by the load control device 106. Thus, in FIG. 4A, all five sensors 102a-e are shown emitting a pulse in the pre-described fashion, indicating that they are all functional properly. FIG. 4B illustrates a pulse scheme received by the load control device in which the second sensor 102b has dropped out (i.e., does not send its pulse), thus indicating that the second sensor has failed. The load control device 106 determines that the defective sensor is sensor 102b due to the absence of the second pulse (VP2) in the overall pulse-group of V1-V5. In a similar manner, FIG. 4C illustrates a pulse scheme in which the fifth sensor 102e has dropped out.

To differentiate between sensor “1” (102a) and the last sensor dropping out, for the case in which sensor “1” (102a) drops out (i.e., 102a fails to emit its pulse VP1), sensor “2” (102b) will wait one extra pulse delay (PD) before sending its pulse VP2. Since its pulse will appear to be that of sensor “1” (since it is the first), this extra delay will make it evident that the first sensor 102a is missing. This is illustrated in FIG. 4D. For the case in which the last sensor 102e (or sensors) fails to send a pulse, the loss is maintained through a power cycle by configuring the load control device 106 with the number of sensors that it should expect. This configuration would also be able to identify where more than one leading sensor missing.

When the load control device 106 identifies a failed occupancy sensor, visual indicator such as a light emitting diode (LED) may be provided on the load control device 106 to indicate failure of the associated occupancy sensor 102a-e. In addition, the load control device 106 may be coupled to a private or public network to facilitate remote notification when a failure of the occupancy sensor 102a-e occurs. In some embodiments sensor failure information may be sent via the Internet to a web page to enable remote monitoring of occupancy sensors. A building manager or other authorized individual or agency may monitor this information to determine if sensor replacement is required. In some embodiments the remote notification may be sent in an e-mail or a text message to one or more mobile or desktop computers.

As with the embodiment of FIGS. 1 and 2, the load control device 106 may be configured to recognize the short periodic voltage pulses as indicators of the sensor's health, and not as an occupancy indication by the sensor. In one embodiment, the processor 122 associated with the load control device 106 may be programmed to distinguish the voltage pulses from normal occupancy signals. In other embodiments, this recognition functionality can be implemented in hardware. Regardless of the specific implementation, the load control device 106 may recognize the received periodic voltage pulses as an indication that the occupancy sensors are healthy, and may distinguish the pulses from a signal indicating that the load 108 should be switched on due to a sensed occupancy condition.

If the load control device 106 does not sense one or more of the periodic pulses, it may recognize this as an indication that one or more of the associated occupancy sensors 102a-e has failed, and it may energize the load 108 to provide illumination of the space associated with the “failed” sensor. In one embodiment, the voltage pulses “VP1”-“VP5” can be applied by the processors 118a-e associated with the occupancy sensors 102a-e. The voltage pulses “VP1”-“VP5” may be recognized by the processor 22 associated with the load control device 6.

In the above described arrangement, the occupancy sensors 102a-e are configured to operate in combination with a load control device 106 that is capable of recognizing “health” signaling from the sensors. The disclosed sensors may, however, be used with conventional load control devices (i.e., devices that are not capable of recognizing these voltage pulses). Thus, the occupancy sensor 102a-e may be configurable to deactivate the health signaling feature. In one embodiment, the occupancy sensors 102a-e may have a dip-switch, button, toggle or other user input that would enable the heartbeat functionality to be turned on or off.

As previously noted, the voltage pulses “VP” may be applied at about +24 Vdc. Thus, the voltage pulses of the FIG. 4A-4D embodiment are the same magnitude as the voltage which is applied to signal an occupied condition of the monitored space. In an alternative embodiment, the voltage pulses “VP” may be driven at a predetermined voltage that is substantially lower than the voltage of a typical occupancy signal (i.e., lower than +24 Vdc). For example, the predetermined voltage may be lower than a logic trip point of the load control device's input. Thus, the predetermined voltage may be less than about +12 Vdc. One advantage of using a reduced voltage pulse is that the occupancy sensors 102a-e configured as such could be used with standard load control devices (i.e., those that don't recognize the voltage pulsing feature) without having to provide a deactivation feature on the sensor. This is because an ordinary load control devices would normally not recognize such a low voltage pulse since the voltage would be below the device's logic trip point. Such an arrangement would not provide the previously described fail-safe functionality, but it would allow the sensors 102a-e to be used with all load control devices, and not just those configured to recognize the applied “health” pulses.

Any of the above described embodiments may be implemented using processors associated with the occupancy sensors 102a-e and a processor associated with the load control device 106. By implementing the arrangement in software associated with the processors, changes to device wiring may be avoided. The scheme may alternatively be implemented using processors associated with the occupancy sensor 102a-e and hardware in the receiver (e.g., RC constants could provide the timeout functionality described above).

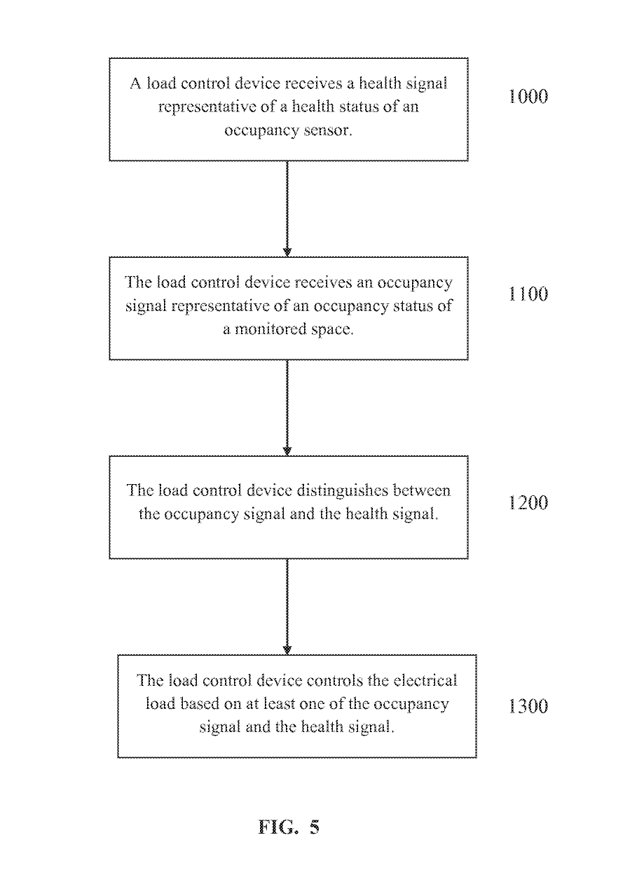

An exemplary method of using the system 1 of FIGS. 1 and 2 will now be described in relation to FIG. 5. At step 1000, the load control device receives a health signal representative of a health status of an associated occupancy sensor. The health signal may comprise a plurality of voltage pulses having a predetermined voltage level, applied at a predetermined pulse period, and having a predetermined pulse rate. The voltage level of the health signal may be below a logic trip point of an input of the load control device. At step 1100, the load control device may receive an occupancy signal representative of an occupancy status of a monitored space. At step 1200 the load control device may distinguish between the occupancy signal and the health signal. At step 1300, the load control device may control the electrical load based on at least one of the occupancy signal and the health signal. In one embodiment, the load control device energizes the electrical load in response to the occupancy signal. The load control device may maintain the electrical load in a current condition in response to the health signal. The current condition of the electrical load may be one of an energized condition and a de-energized condition. The load control device may energize the electrical load when the health signal is not received within a predetermined time period.

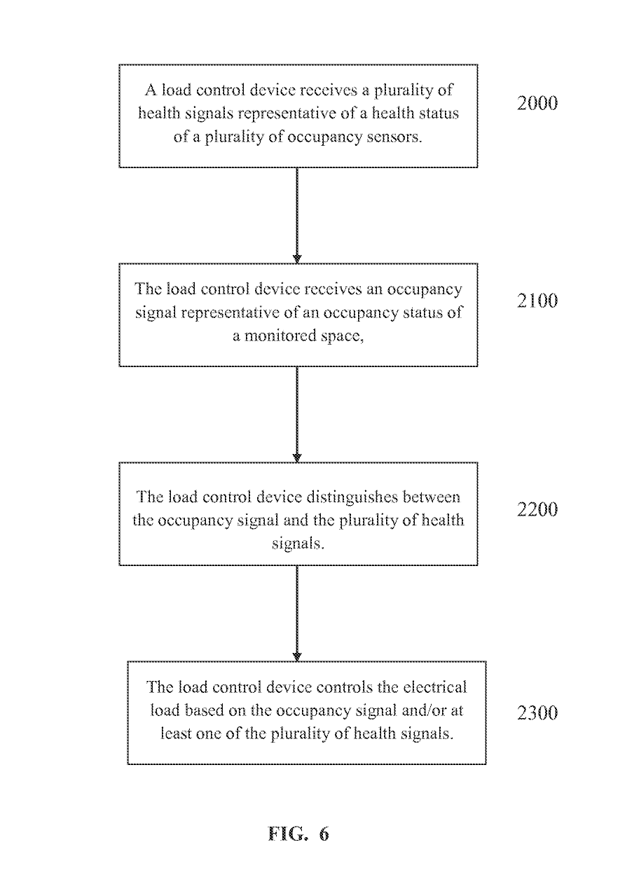

An exemplary method of using the system 100 of FIGS. 3-4D will now be described in relation to FIG. 6. At step 2000, the load control device receives a plurality of health signals representative of a health status of a plurality of associated occupancy sensor. The health signals may comprise a plurality of voltage pulses having a predetermined voltage level. The health signals may comprise voltage pulses having a predetermined pulse period, and a predetermined pulse rate. The voltage level of the health signals may be below a logic trip point of an input of the load control device. At step 2100, the load control device may receive an occupancy signal from one of the plurality of associated occupancy sensors. The occupancy signal may be representative of an occupancy status of a monitored space. At step 2200 the load control device may distinguish between the occupancy signal and the plurality of health signals. At step 2300, the load control device may control the electrical load based on the occupancy signal and/or at least one of the plurality of health signals. In one embodiment, the load control device energizes the electrical load in response to the occupancy signal. The load control device may maintain the electrical load in a current condition in response to at least one of the plurality of health signals. The current condition of the electrical load may be one of an energized condition and a de-energized condition. The load control device may energize the electrical load when at least one of the plurality of health signals is not received within a predetermined time period.

Some of the inventive principles of the disclosure relate to techniques for occupancy sensing, in particular, for sensing the presence or motion of a person or a moving object in an area of interest. In one embodiment, lighting levels can be adjusted in or about the area of interest responsive to sensing the person or moving object. In another embodiment, a security alarm can be triggered responsive to sensing the person or moving object.

The disclosed system and method may provide enhanced safety for occupancy sensing systems used to monitor spaces for which public safety is implicated. Embodiments of the disclosed occupancy sensor can be used with a conventional load control devices or enhanced load control devices to provide the desired fail safe illumination of such spaces.

Some embodiments of the disclosed device may be implemented, for example, using a storage medium, a computer-readable medium or an article of manufacture which may store an instruction or a set of instructions that, if executed by a machine (i.e., processor or microcontroller), may cause the machine to perform a method and/or operations in accordance with embodiments of the disclosure. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory (including, but not limited to, non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision additional modifications, features, and advantages within the scope and spirit of the claims appended hereto.

What is claimed is:

1. A load control system, comprising:
an occupancy sensor for providing an occupancy signal representative of occupancy of a monitored area, and for providing a health signal representative of a health of the occupancy sensor;
a load control device coupled to the occupancy sensor, the load control device configured to receive the occupancy signal and the health signal from the occupancy sensor, and to control an electrical load based on at least one of the received occupancy signal and the health signal.

2. The load control system of claim 1, wherein the occupancy signal is a voltage signal having a predetermined voltage.

3. The load control system of claim 2, wherein the predetermined voltage is about +24 Vdc.

4. The load control system of claim 2, wherein the health signal is a voltage signal having a predetermined voltage and a predetermined pulse period.

5. The load control system of claim 4, wherein the load control device is configured to distinguish between the occupancy signal and the health signal, to energize the electrical load in response to the occupancy signal, and to maintain the electrical load in a current condition in response to the health signal.

6. The load control system of claim 5, wherein the current condition of the electrical load is one of an energized condition and a de-energized condition.

7. The load control system of claim 1, wherein the load control device is configured to energize the electrical toad when the health signal is not received within a predetermined time period.

8. The load control system of claim 1, wherein the health signal comprises a series of voltage pulses having a predetermined puke period, and a predetermined pulse rate.

9. The load control system of claim 1, wherein the health signal comprises a series of voltage pulses having a voltage level that is different from a voltage level of the occupancy signal.

10. The load control system of claim 1, wherein the voltage level of the health signal is below a logic trip point of an input of the load control device.

11. The load control system of claim 1, wherein
the occupancy sensor comprises a plurality of occupancy sensors, each of said plurality of occupancy sensors configured to provide an occupancy signal representative of occupancy of a monitored area, and for providing a health signal representative of a health of the associated occupancy sensor;
wherein the load control device is coupled to the plurality of occupancy sensors, the load control device configured to receive the occupancy signals from at least one of the plurality of occupancy sensors, and to receive the plurality of health signals from the plurality of occupancy sensors, and to control an electrical load based on at least one of the received occupancy signal and the received plurality of health signals.

12. The load control system of claim 11 wherein the plurality of health signals comprise recurring sets of pulse groups, each pulse group including a voltage pulse associated with each one of the plurality of occupancy sensors.

13. The load control system of claim 12, wherein the load control device is configured to determine which voltage pulse in each of said pulse groups is associated with a particular one of said plurality of occupancy sensors.

14. A method for controlling an electrical load using an occupancy sensor, comprising:
receiving, at a load control device, a health signal representative of a health status of the occupancy sensor;
receiving, at the load control device, an occupancy signal representative of an occupancy status of a monitored space; and
controlling an electrical load based on at least one of the occupancy signal and the health signal.

15. The method of claim 14, wherein controlling an electrical load comprises energizing the electrical load, de-energizing the electrical load, or maintaining the electrical load in a current condition.

16. The method of claim 14, wherein receiving a health signal comprises receiving a plurality of voltage pulses having a predetermined voltage level.

17. The method of claim 16, wherein receiving a health signal comprises receiving a plurality of voltage pulses having a predetermined pulse period.

18. The method of claim 16, wherein receiving a health signal comprises receiving a plurality of voltage pulses having a predetermined pulse rate.

19. The method of claim 14, further comprising, at the load control device, distinguishing between the occupancy signal and the health signal, energizing the electrical load in response to the occupancy signal, and maintaining the electrical load in a current condition in response to the health signal.

20. The method of claim 19, wherein the current condition of the electrical load is one of an energized condition and a de-energized condition.

21. The method of claim 14, further comprising, at the load control device, energizing the electrical load when the health signal is not received within a predetermined time period.

22. The method of claim 14, wherein the health signal comprises a series of voltage pulses having a voltage level that is different from a voltage level of the occupancy signal.

23. The method of claim 14, wherein the voltage level of the health signal is below a logic trip point of an input of the load control device.

24. The method of claim 14, further comprising:
receiving, at the load control device, a plurality of health signals representative of a health status of a plurality of occupancy sensors;
wherein controlling an electrical load comprises controlling the load based on at least one of the occupancy signal and the plurality of health signals.

25. The method of claim 24, wherein the plurality of health signals are received as recurring sets of pulse groups, each pulse group including a voltage pulse associated with each one of the plurality of occupancy sensors.

26. The method of claim 25, wherein the load control device is configured to determine which voltage pulse in each of said pulse groups is associated with a particular one of said plurality of occupancy sensors.
